(19) United States
(12) Patent Application Publication
(10) Pub. No.: US 2022/0122335 A1
(43) Pub. Date: Apr. 21, 2022

(54) SCALING AND RENDERING VIRTUAL HAND

(71) Applicant: Hewlett-Packard Development Company, L.P., Spring, TX (US)

(72) Inventors: Ian N Robinson, Palo Alto, CA (US); David Bradley Short, San Diego, CA (US); Fred Charles Thomas, III, Fort Collins, CO (US); Andrew Hunter, Bristol (GB); Robert Rawlings, Fort Collins, CO (US)

(73) Assignee: Hewlett-Packard Development Company, L.P., Spring, TX (US)

(21) Appl. No.: 17/418,979

(22) PCT Filed: Mar. 21, 2019
(86) PCT No.: PCT/US2019/023444

§ 371 Date: Jun. 28, 2021

(51) Int. Cl. G06T 19/20; G06T 15/00; G06F 3/041; G06V 40/10; G06F 3/0354

(52) U.S. Cl. CPC G06T 19/20; G06T 15/00; G06F 3/03545; G06V 40/107; G06F 3/041

(57) ABSTRACT

Methods, systems, apparatus, and computer-readable media (transitory or non-transitory) are described herein for scaling and rendering a virtual hand. According to an example, vision data may be received from a three-dimensional (“3D”) vision sensor. The vision data may capture at least a portion of a user in an environment, and may include data representing the user's hand relative to a touch interaction surface. The vision data may be processed to generate a 3D representation of the user's hand. A scaling center may be identified on the touch interaction surface to scale the 3D representation of the user's hand. The 3D representation of the user's hand may be scaled with respect to the identified scaling center using a scaling factor. The scaling factor may be based on a rendering constraint. A virtual hand may be rendered, e.g., on a display, based on the scaled 3D representation of the user's hand.

### BACKGROUND

Touchscreen technology can be used to facilitate display interaction on mobile devices such as smart phones and tablets, as well as with personal computers (“PC”) with larger screens, e.g., desktop computers. However, as touchscreen sizes increase, the cost for touchscreen technology may increase exponentially. Moreover, larger touchscreens may result in “gorilla arm”—the human arm held in an unsupported horizontal position rapidly becomes fatigued and painful—when using a large-size touchscreen. A separate interactive touch surface such as a trackpad may be used as an indirect touch device that connects to the host computer to act as a mouse pointer when a single finger is used. The trackpad can be used with gestures, including scrolling, swipe, pinch, zoom, and rotate.

### BRIEF DESCRIPTION OF THE DRAWINGS

Features of the present disclosure are illustrated by way of example and not limited in the following figure(s), in which like numerals indicate like elements.

FIG. 1 depicts an example environment in which selected aspects of the present disclosure may be implemented.

FIG. 2 schematically depicts a block diagram of example components, some of which may implement selected aspects of the present disclosure.

FIGS. 3A and 3B depict examples of how a 3D representation of a user's hand may be scaled, according to an example of the present disclosure.

FIGS. 4A and 4B depict examples of how touch events detected by an interactive touchpad may be scaled, according to an example of the present disclosure.

FIGS. 5A and 5B depict examples of how a stylus may be detected, scaled, and rendered virtually, according to an example of the present disclosure.

FIGS. 6A and 6B depict examples of how multiple hands may be detected, scaled, and rendered virtually, according to an example of the present disclosure.

FIG. 7 depicts an example method for practicing selected aspects of the present disclosure.

FIG. 8 depicts an example method for practicing selected aspects of the present disclosure.

FIG. 9 depicts an example method for practicing selected aspects of the present disclosure.

FIG. 10 shows a schematic representation of a computing device, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

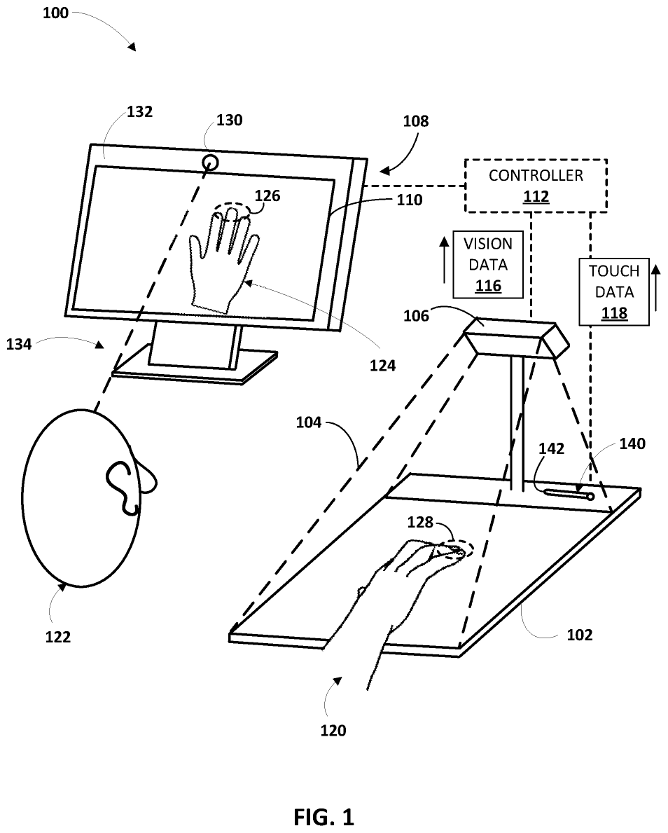

Referring now to FIG. 1, an example system 100 configured with selected aspects of the present disclosure is depicted schematically. In FIG. 1, system 100 includes a touch interaction surface 102 within a field of view (“FOV”) 104 of a three-dimensional (“3D”) vision sensor 106. System 100 also includes a computing device 108 that includes a display 110 that is integral with computing device 108. Display 110 may or may not be a touchscreen display. As depicted in phantom in FIG. 1, computing device 108 includes an integral controller 112. However, this is not meant to be limiting, and in other examples, computing device 108 may take other forms, such as a tower that is operably coupled with a standalone display, a laptop computer, a convertible laptop that is convertible into a touch screen, and so forth. Moreover, display 110 is not limited to a computer monitor. In some examples, display 110 may take other forms, such as display(s) forming part of a head-mounted display (“HMD”), or a projector screen or surface that is the target of a projector.

Controller 112 may take various forms. In some examples, controller 112 takes the form of a processor, or central processing unit (“CPU”), or even multiple processors, such as multi-core processor. Such a processor may execute instructions stored in memory (not depicted in FIG. 1) to perform selected aspects of the present disclosure. Additionally or alternatively, controller 112 may take the form of an application-specific integrated circuit (“ASIC”) that performs selected aspects of the present disclosure, a field-programmable gate array (“FPGA”) that performs selected aspects of the present disclosure and/or other types of circuitry that are operable to perform logic operations. In this manner, controller 112 may be circuitry or a combination of circuitry and executable instructions.

Controller 112 is operably coupled with 3D vision sensor 106, e.g., using various types of wired and/or wireless data connections, such as universal serial bus (“USB”), wireless local area networks (“LAN”) that employ technologies such as the Institute of Electrical and Electronics Engineers (“IEEE”) 802.11 standards, personal area networks, mesh networks, and so forth. Accordingly, vision data 116 captured by 3D vision sensor 106 is provided to controller 112. Controller 112 is likewise operably coupled with touch interaction surface 102—which in this example takes the form of a touch sensor or “interactive touch surface”—using the same type of connection as was used for 3D vision sensor 106 or a different type of data connection. Accordingly, touch data 118 captured by touch interaction surface 102 is provided to controller 112. However, in other examples, touch interaction surface 102 may be passive, and physical contact with touch interaction surface 102, e.g., by a hand 120 of a user 122, may be detected using vision data 116 alone. For example, touch interaction surface 102 may simply be a portion of a desktop or other work surface that is within FOV 104 of 3D vision sensor 106.

In some examples in which touch interaction surface 102 is interactive and generates touch data 118, touch interaction surface 102 may include a screen. For example, touch interaction surface 102 may take the form of a touchscreen tablet. In some such examples, a user may operate the tablet, e.g., using a hard or soft input element, or a gesture, to transition stylus/touch interactivity from the tablet to a separate display, such as display 110. This may include examples in which touch interaction surface 102 itself is a computer, with controller 112 integrated therein, as may be the case when touch interaction surface 102 takes the form of a laptop computer that is convertible to a tablet form factor.

3D vision sensor 106 may take various forms. In some examples, 3D vision sensor 106 may operate in various ranges of the electromagnetic spectrum, such a visible, infrared, etc. In some examples, 3D vision sensor may detect 3D/depth information. For example, 3D vision sensor 106 may include array of sensors to triangulate and/or interpret depth information. In some examples, 3D vision sensor may take the form of a multi-camera apparatus such as a stereoscopic and/or stereographic camera. In some examples, 3D vision sensor 106 may take the form of a structured illumination apparatus that projects known patterns of light onto a scene, e.g., combined in combination with a single or multiple cameras. In some examples, 3D vision sensor may include a time-of-flight apparatus with or without single or multiple cameras. In some examples, vision data 116 may take the form of two-and-a-half-dimensional (“2.5D”) (2D with depth) image(s), where each of the pixels of the 2.5D image defines an X, Y, and Z coordinate of a surface of a corresponding object, and optionally color values (e.g., R, G, B values) and/or other parameters for that coordinate of the surface. In some examples, 3D vision sensor 106 may take the form of a 3D laser scanner.

In some examples, 3D vision sensor 106 may capture vision data 116 at a framerate and/or accuracy that is sufficient to generate, in “real time,” 3D representation of a hand 120 of a user 122. In some examples, this 3D representation of hand 120 may take the form of a skeletal representation that includes, for instance, wrist and finger joints. In other examples, it may take the form of a 3D point cloud, a wireframe structure, and so forth.

Additionally or alternatively, in some examples, multiple sensors may be employed in tandem to determine a position, size, and/or pose of hand 120, from which a 3D representation of hand 120 may be generated. For example, one 2D vision sensor may be positioned over touch interaction surface 102 to capture a silhouette of hand 120. At the same time, touch data 118 may indicate locations of touch events on touch interaction surface 102. These signals may be combined to estimate a size, position, and/or pose of hand 120. Additionally or alternatively, ultrasound sensors may be deployed to detect, for instance, a height of hand 120.

Based on vision data 116 received from 3D vision sensor 106 and/or touch data 118 received from touch interaction surface, controller 112 may cause a virtual hand 124 to be rendered on display 110. Virtual hand 124 may be transparently or translucently overlaid on other displayed elements (not depicted in FIG. 1), e.g., so that the other displayed elements are visible through virtual hand 124. Virtual hand 124 may also indicate a virtual touch 126, corresponding to a sensed touch 128 of the user's hand 120 on touch interaction surface 102.

In some examples, including that of FIG. 1, computing device 108 includes a camera 130, e.g., disposed in a bezel 132 of display 110. Camera 130 may be a two-dimensional camera such as an RGB camera and/or a 3D camera similar to 3D vision sensor 106. In some examples, camera 130 may capture image(s) of user 122. These images may be processed, e.g., by controller 112, to determine a distance 134 between user 122 and display 110. As will be described in more detail herein, the distance 134 may be a “rendering constraint” that is used to determine a scaling factor for rendering virtual hand 124 on display 110. Another rendering constraint that may be used to determine such a scaling factor is a dimension of touch interaction surface 102, e.g., in relation to display 110. Other rendering constraints, both physical and virtual, will be described herein.

Also depicted in FIG. 1 is a stylus 140 that may be used by user 122 to interact with touch interaction surface 102. For example, user 122 may grasp stylus 140 in the user's hand 120 so that user 122 can use stylus 140 to provide fine-tuned touch-based input, such as writing, drawing, etc. Stylus 140 includes a nib 142 at one end that may be pressed against touch interaction surface 102 by user 122, e.g., to write, draw, etc. In some examples, stylus 140 may include onboard circuitry or other components, such as gyroscopes, accelerometers, magnetometers, etc., that enable a pose of stylus 140 to be detected. The stylus pose may include, for example, an orientation of stylus 140, an angle or tilt of stylus 140 relative to a normal from touch interaction surface 102, a location of nib 142, and so forth.

In some examples, a placement and/or configuration of 3D vision sensor 106 may be selected so that FOV 104 captures at least the extent of touch interaction surface 102, e.g., so that 3D vision sensor 106 is able to detect when hand 120 extends over touch interaction surface 102. In some examples, FOV 104 of 3D vision sensor 106 may cover a volume extending some distance vertically above touch interaction surface 102, e.g., a few inches. This may allow for detection of things like, for instance, a user's fingers hovering an inch above the lower edge of touch interaction surface 102. Additionally or alternatively, in some examples, FOV 104 of 3D vision sensor 106 may extend farther towards user 122 such that the entirety of hand 120 is captured even when user 122 only extends hand 120 over the lower portion of touch interaction surface 102. In some examples, FOV 104 may extend even farther towards user 122 such that 3D vision sensor 106 is able to see the whole of the user's hand 120 when the user's fingertips are at a lower edge of touch interaction surface 102.

In FIG. 1, 3D vision sensor 106 is depicted mounted over touch interaction surface 102, with its FOV 104 pointed downward toward touch interaction surface 102. However, this is not meant to be limiting. In other examples, 3D vision sensor 106 may be mounted at other locations at which its FOV 104 still captures touch interaction surface 102. As one example, 3D vision sensor 106 may be a portable sensor that is mountable on bezel 132 of display 110, e.g., in a manner similar to “web cams” that are often also equipped with microphones. In yet other examples, 3D vision sensor 106 may be integral with display 110, e.g., as part of bezel 132 similar to camera 130.

In some examples, a calibration routine may be implemented to establish a location of 3D vision sensor 106 with respect to touch interaction surface 102. If 3D vision sensor 106 is physically coupled to touch interaction surface 102, as is depicted in FIG. 1, then calibration may performed at assembly or manufacture. However, in many examples, 3D vision sensor (or multiple sensors acting in conjunction, if applicable) may be portable, e.g. it may be a clip-on accessory to display 110 as described previously. In some such examples, touch interaction surface 102 may be equipped with calibration indicia such as infrared light-emitting diodes to help determine a position and orientation of touch interaction surface 102 with respect to 3D vision sensor 106. This calibration may be performed continuously and/or periodically, e.g., on a set schedule or when movement of a component of system 100 is detected. For example, vision data 116 may be analyzed on occasion to check that calibration indicia on touch interaction surface 102 are in their expected positions. As another way to perform calibration, vision data 116 may be monitored to detect a position and/or pose of stylus 140 and compare that to what is reported by touch interaction surface 102 in touch data 118.

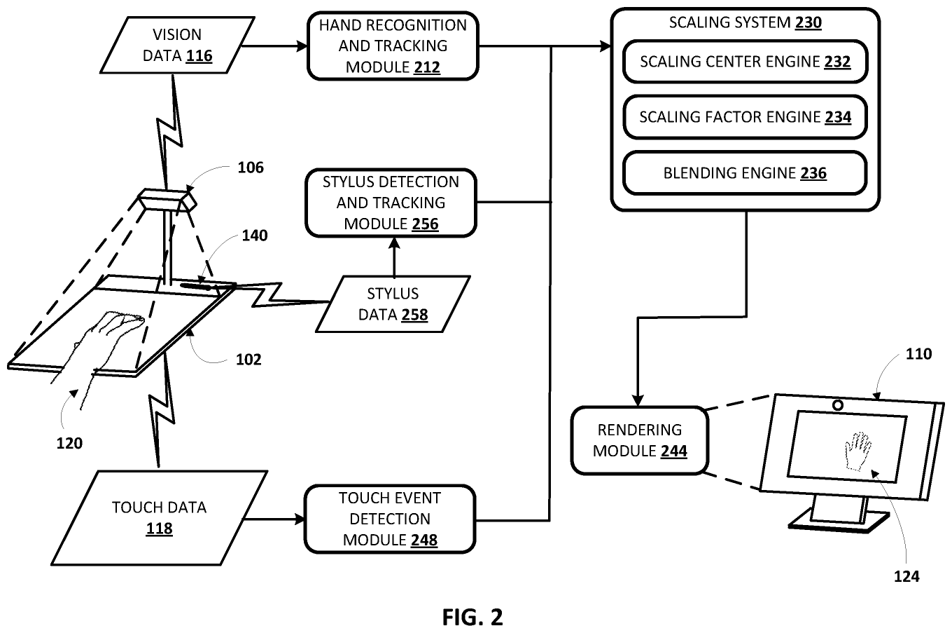

FIG. 2 schematically depicts one example of how various components depicted in FIG. 1 may interact when selected aspects of the present disclosure are implemented. Various modules and engines are depicted in FIG. 2 for performing various operations. These modules and/or engines may be implemented using any combination of hardware or machine-readable instructions, and in some examples may be performed in whole or in part by controller 112.

As described previously, 3D vision sensor 106 generates vision data 116 and touch interaction surface 102 generates touch data 118. Vision data 116 is provided to a hand recognition and tracking module 212. Hand recognition and tracking module 212 processes vision data 116—and in some examples, other data from other sensors, such as touch data 118—to generate a 3D representation of the user's hand 120. As noted previously, in some examples the 3D representation of the user's hand 120 takes the form of a skeletal model.

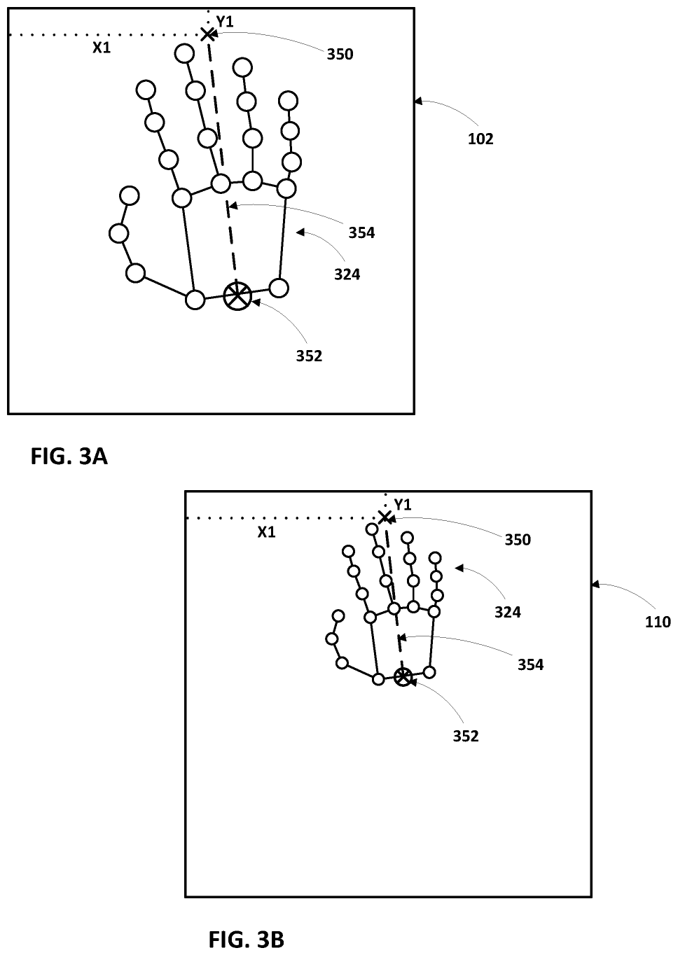

One example of a skeletal hand model 324 is depicted in FIGS. 3A and 3B. In this example, skeletal hand model 324 includes a series of nodes that correspond to fingertips and joints of the user's hand 120 and wrist. Lines connecting the nodes correspond to bones or other connective components of the user's hand 120. Put another way, skeletal hand model 324 conveys a 3D location of each of these nodes, and hence, of each of the corresponding joints. Other representations of the user's hand 120 are contemplated herein, such as a 3D point cloud representation of a surface of the user's hand 120.

The size of the user's hand 120 relative to touch interaction surface 102 may or may not be desirable for recreation on display 110. For example, FIG. 3A depicts an unscaled skeletal hand model 324 of the user's hand 120 over an unscaled representation of touch interaction surface 102. It can be seen that skeletal hand model 324 occupies a substantial portion of touch interaction surface 102, which is the case because the user's hand 120 occupies a large portion of touch interaction surface 102. Put another way, the ratio of 2D dimensions of touch interaction surface 102 to skeletal hand model 324 is relatively small. If the same ratio were maintained when virtual hand 124 is rendered on display 110, then virtual hand 124 would occupy nearly the whole screen, which would not likely be a good experience for user 122.

Accordingly, and referring back to FIG. 2, the 3D representation of the user's hand 120 generated by hand recognition and tracking module 212 may be provided to, and scaled by, a scaling system 230. Scaling system 230 resizes or scales the 3D representation of the user's hand 120 and provides it to a rendering module 244.

Rendering module 244 causes virtual hand 124 to be rendered on display 110. In many examples, rendering module 244 renders virtual hand 124, and a virtual stylus if stylus 140 is detected, from a viewpoint above touch interaction surface 102. In some examples the rendering may be orthographic, e.g., so that vertical movement of hand 120 towards/away from touch interaction surface 102 does not result in any change in virtual hand 124. Alternatively, the user raising their hand vertically may result in changing the scaling of virtual hand 124, e.g. increasing its displayed size by +10%, but does not affect its position. Changes in vertical height of hand 120 from touch interaction surface 102 may also be visually indicated in other ways, such as fading, blurring, to changing a color of virtual hand 124, or adding some indication mechanism to virtual hand 124, such as shapes at each fingertip that expand and fade with vertical height of hand 120 from touch interaction surface 102.

Rather than dominating nearly all of display 110, because of the scaling performed by scaling system 230, rendering module 244 renders virtual hand 124 to occupy a smaller portion of display 110 than it would unscaled. Consequently, in some examples, virtual hand 124 may appear more life-sized, providing user 122 with a better and/or more intuitive experience.

In various examples, virtual hand 124 may be rendered in various ways based on the 3D representation of the user's hand 120. A user may be able to select how virtual hand 124 is rendered from these options. For example, a user may be able to select whether virtual hand 124 is rendered to appear realistic or abstract. In one example, the 3D representation itself is rendered on display 110 as virtual hand 124. Additionally or alternatively, in some examples, virtual hand 124 may be rendered by projecting the 3D representation of the user's hand onto the display as a 2D projection, which may be rendered variously as a silhouette, a shadow hand, cartoon outlined hand, a wireframe hand, etc. In yet other examples, virtual hand 124 may be rendered as a skeletal hand. In some examples, virtual hand 124—and the virtual stylus if actual stylus 140 is detected—may be alpha-blended with underlying content already rendered on display 110. Consequently, virtual hand 124 may appear at least partially transparent so that the underlying display content is still visible.

In FIG. 2, scaling system 230 includes a scaling center engine 232, a scaling factor engine 234, and a blending engine 236. One or more of engines 232-236 may be omitted and/or combined with other engines or modules depicted in FIG. 2. Scaling center engine 232 identifies a point on the touch interaction surface that is to be used as a “scaling center” to scale the 3D representation of the user's hand. The 3D representation of the user's hand 120 will be scaled with respect to this scaling center. An example of a scaling center is indicated at 350 in FIGS. 3A-B.

Scaling center engine 232 may identify a scaling center at various locations. In some examples, scaling center engine 232 may identify, as a scaling center, a primary point of physical interaction between user 122 and touch interaction surface 102. This might correspond, for example, with the finger or finger(s) most commonly used for touch operations, which might vary between one user who uses a particular type of touch gesture more frequently than another user. In FIGS. 3A-B, scaling center engine 232 identifies scaling center 350 as a point in between the tips of the user's middle and ring fingers that is likely to be touched by user 122. To identify such a point, scaling center engine 232 may analyze vision data 116 using various techniques, such as object recognition, to identify a location of finger(s) of the user's hand 120. Other points may be designated as scaling centers, including but not limited to nib 142 of stylus 140 grasped by user 122. And in some examples, the scaling center may be user-adjustable.

Referring back to FIG. 2, scaling factor engine 234 may determine a “scaling factor” to be used when scaling the 3D representation of the user's hand 120. The scaling factor may be a numeric value or values that are used to determine how much to scale the 3D representation before passing it to rendering module 244. Scaling factor engine 234 may take into account various rendering constraints to determine the scaling factor. In one example, the scaling factor may be determined based on physical rendering constraints such a dimension of a display D_{D} to be used to render the scaled 3D representation of the user's hand, e.g., display 110 in FIG. 1, and its relationship to a dimension D_{T} of touch interaction surface 102. As mentioned earlier, the scale factor may also be influenced by the detected height of the user's hand above the touch interaction surface. Another example physical rendering constraint is a distance d_{e→d} of a user's eye from touch interaction surface 102, and its relationship to a distance d_{e→D} of the user's eye from the display on which virtual hand 124 is to be rendered. For example, if user 122 is sufficiently distant from display 110, e.g., in scenarios in which the display is a projection screen several feet or more away from user 122, then a virtual hand rendered life size on the projection screen may look too small.

In some examples, the following equation may be employed to determine the scaling factor SF:

$$SF = \frac{{D}_{T}}{{D}_{D}} \times \frac{{d}_{e \to T}}{{d}_{e \to D}}$$

The first term

$$\frac{{D}_{T}}{{D}_{D}}$$

relates the whole display area D_{D} to all or part of the touch interaction surface 102 area D_{T}. This relationship may include accommodating aspect ratio mismatches between display 110 and touch interaction surface 102, as well as allowing user 122 to map all or a portion of touch interaction surface 102 onto display 110.

The second term

$$\frac{{d}_{e \to T}}{{d}_{e \to D}}$$

ensures that virtual hand 124/324 rendered on the display subtends a similar visual angle for user 122 as the user's hand 120 on touch interaction surface 102. As noted previously, the distance 134 between user 122 and display 110 may be determined using, for instance, vision data captured by camera 130. In some examples, user 122 may have the ability to adjust and save a preferred scaling factor and/or scaling center. In some such examples, user 122 may associated these preferences with preset options such as “desktop,” “presentation,” and so forth.

In other examples, scaling center engine 232 may determine the scaling factor based on non-physical, or “virtual” rendering constraints. One type of virtual rendering constraint may be an application window having a current focus; such an application window may occupy less than the entirety of display 110. Alternatively, suppose that instead of viewing a display that is more or less perpendicular to touch interaction surface 102, as is depicted in FIG. 1, user 122 is wearing and operating an HMD that provides user 122 with a virtual reality (“VR”) and/or augmented reality (“AR”) experience. It might not make sense to render virtual hand 124 from an overhead perspective in the VR/AR context, because the user may be interacting with some surface that is not necessarily perpendicular to touch interaction surface 102. Accordingly, in some examples, virtual rendering constraints may include an orientation and/or size of a virtual surface that user 122 interacts with using touch interaction surface 102. Suppose user 122 plays a VR game in which user 122 interacts with an oblique surface such as virtual dashboard to control a vehicle. Rendering virtual hand 124 on such an oblique surface might dictate different rotation and/or translation than rending virtual hand 124 on a vertically-oriented display.

Note that the scale factor applied to the 3D representation of the user's hand, described by the equation above, may be different from the scale factor used to transform the position of that representation on touch interaction surface 102 to a position on the display 110. The latter scale factor may only include the

$$\frac{{D}_{T}}{{D}_{D}}$$

term in the above.

Blending engine 236 receives the scaled 3D representation of the user's hand and, if applicable, blends it with other 3D data. For example, and as will be described below, if user 122 grasps stylus 140 over touch interaction surface 102, a 3D representation of stylus 140 may be generated, e.g., based on a detected pose of stylus. This 3D representation of stylus 140 may then be blended with the 3D representation of the user's and 120 by blending engine 236.

As noted previously, in some examples, touch interaction surface 102 generates touch data 118. In FIG. 2, touch data 118 is received by a touch event detection module 248. Touch event detection module 248 may provide data indicative of touch data 118, such as touch data 118 itself or data indicative of touch events, to scaling system 230. Scaling system 230 may scale the touch events in a manner similar to how it scales the 3D representation of the user's hand, e.g., so that the touch events are properly represented by virtual hand 124.

A stylus detection and tracking module 256 may receive stylus data 258 from stylus 140, and/or from touch interaction surface 102 in examples in which stylus and touch interaction surface 102 operate in cooperation. As described herein, in some examples, when stylus 140 is detected as being grasped by user 122, e.g., by stylus detection and tracking module 256 or by scaling system 230, the scaling center may be identified as nib 142 of stylus. Data indicative of stylus data 258, such as stylus position and/or pose, may be provided to scaling system 230.

FIGS. 3A-B demonstrate one example of how scaling system 230 may scale skeletal hand model 324, and more generally, a 3D representation of a user's hand. FIGS. 3A-B are depicted from a viewpoint looking directly down at touch interaction surface 102, which ultimately may be the viewpoint that is rendered on display 110 in some examples. As noted above, the use of a 3D vision sensor 106 allows a 3D representation of the user's hand 120 to be generated, which can then be rendered from an alternative viewpoint for use on the display 110. Thus 3D vision sensor 106 may be mounted on top of the display 110, off to the side of touch interaction surface 102, or elsewhere, and may capture a 3D representation of the user's hand from any of those viewpoints. Rendering module 244 may then generate a view of that 3D representation of the user's hand using an alternative virtual viewpoint located directly above the touch interaction surface.

In FIG. 3A, skeletal hand model 324 is depicted over touch interaction surface 102. Skeletal hand model 324 also includes a joint 352 in the user's wrist. In some examples, the scaling center 350 may be identified on touch interaction surface 102 as a location at a fixed offset 354 from the joint in the user's wrist. In some examples, the fixed offset 354 may be learned, e.g., by scaling center engine 232, based on previous interactions with touch interaction surface 102 by user 122. For example, a size or length of hand 120 may be learned over time from vision data 116, manually input by the user, e.g., as part of a calibration routine, and so forth. In some examples in which multiple users may engage with system 100, a different fixed offset may be determined for each user, based on vision data 116, manual input, etc.

FIG. 3B demonstrates how skeletal hand model 324 can be scaled about scaling center 350 on display 110 based on a scaling factor. In FIG. 3B, the proportion of skeletal hand model 324 to display 110 is less than the proportion of skeletal hand model 324 to touch interaction surface depicted in FIG. 3A. This may help user more easily interact with content rendered on display 110.

It can be seen in FIGS. 3A-B that throughout the scaling process, scaling center 350 remains at fixed horizontal and vertical offsets (X1, Y1) from the edges of touch interaction surface 102 and display 110, respectively. Scaling relative to wrist joint 352, as opposed to scaling about the fingertips, may allow for the scaled bulk of skeletal hand model 324, or more generally, virtual hand 124, including the palm and/or wrist, to remain in a fixed position as the user's fingers are flexed. Additionally, offsetting scaling from the wrist to the typical area of the fingertips avoids rendering the user's fingers as part of virtual hand 124 when the user's fingers are moved past a top edge of touch interaction surface 102. As noted earlier, it should be understood that a transform applied to a position of virtual hand 124 may be different than a transform applied to virtual hand 124 itself.

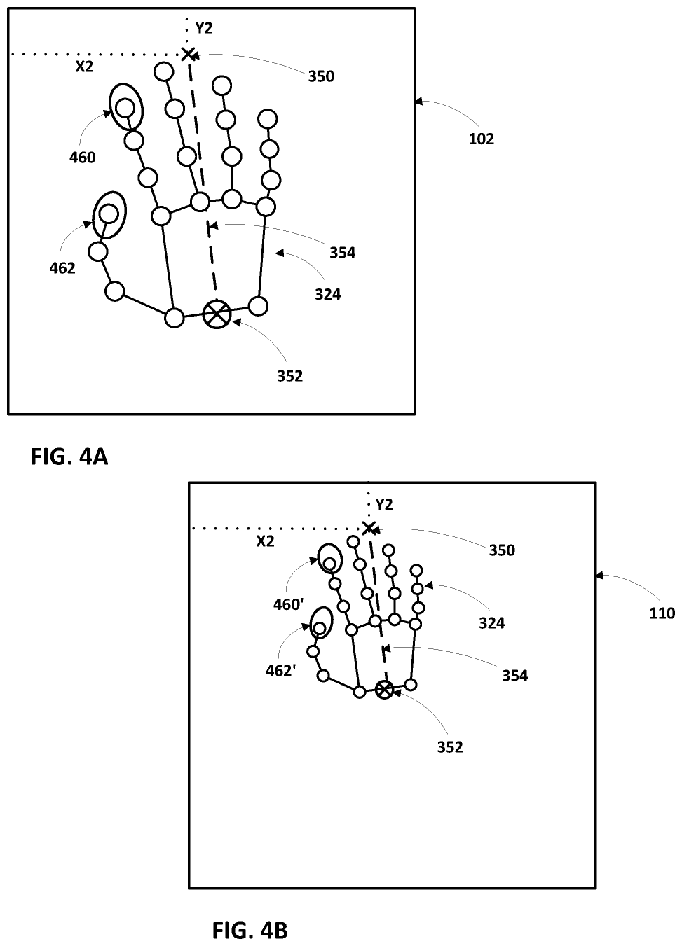

FIGS. 4A-B are similar in many respects to FIGS. 3A-B, and thus, corresponding elements are referenced with the same numerals. However, FIGS. 4A-B are different in that they demonstrate one example of how touch events captured in touch data 118 received from touch interaction surface 102 may be scaled onto display 110. In FIG. 4A, two touch events, 460 and 462, are detected in response to contact by the user's index finger and thumb, respectively, with touch interaction surface 102.

For multi-touch gestures such as that represented by 460 and 462, the scaling that is applied to the 3D representation of the user's hand might result in the finger touch locations appearing closer together on the display than they physically occur on touch interaction surface 102. Accordingly, the touch events generated by touch interaction surface 102 may be scaled, e.g., by scaling system 230, in the same or similar manner as the 3D representation of the user's hand before being passed on to controller 112, so that scaled touch events 460′, 462′ correspond to the locations of the fingers on virtual hand 124. In FIG. 4B, these scaled touch events 460′, 462′ are scaled along with the rest of skeletal hand model 324, e.g., using the same scaling center 350 and offset 354 from the joint 352 of the user's wrist. Touch events need not necessarily be exactly coincident with the fingerprints of skeletal hand model 324, but this information may be used for calibration purposes.

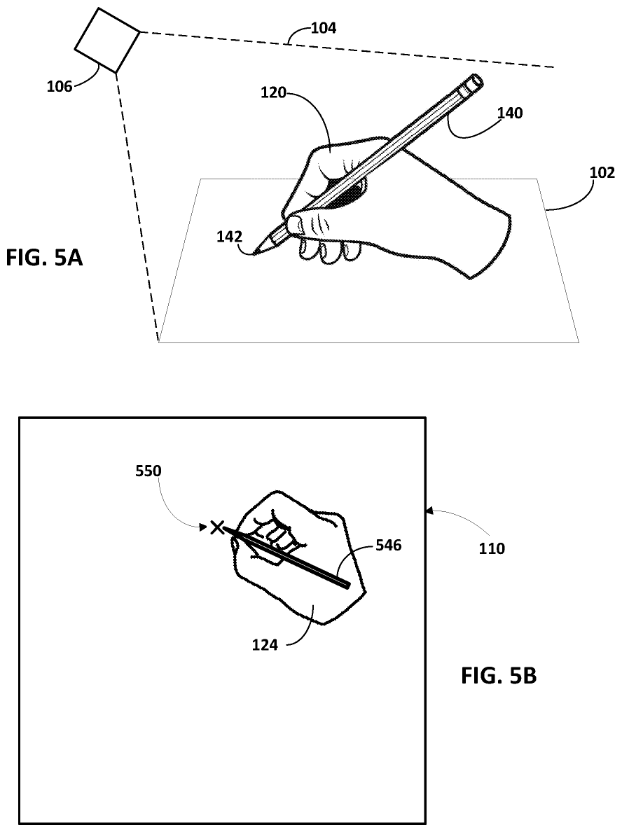

When stylus 140 is detected in the user's grasp, e.g., from vision data 116, from touch data 118, or from other sensor(s) such as stylus 140 itself, virtual hand 124 may be rendered differently to represent the user's hand holding an avatar of stylus 140. As noted previously, in various examples, the pose of stylus 140, which may include its position, tilt, etc., may be determined from any of the aforementioned data sources and used to render virtual hand 124 holding an avatar of stylus 140. Referring now to FIGS. 5A-B, in some examples, when stylus 140 is detected, e.g., within FOV 104 of 3D vision sensor 106, the scaling center may be identified as nib 142 of stylus 140. As shown in FIG. 5B, when virtual hand 124 is rendered on display 110 holding a virtual stylus 546, scaling center 550 is identified at a point coincident, or at least proximate to, nib 142 of stylus 140.

Because virtual stylus 546 is scaled about the scaling center 550 at its tip, the location at which nib 142 contacts touch interaction surface 102 is unaffected by scaling applied to virtual stylus 546, and thus, the location can be passed directly to, for instance, an operating system of the computing device. In some examples, if a change in scaling center 550 is significant when starting or ending stylus use, that is, when transitioning between a hand-based scaling center and a stylus-based scaling center, the change in the scaling center's position may be animated over some small interval of time to make the change less visually abrupt.

In some examples, virtual stylus 546 may be rendered disguised as a user-selected tool. For example, a user operating a graphic design or photo editing application may have access to a number of drawing tools, such as airbrush, paintbrush, erasers, pencils, pens, etc. Rather than rendering virtual stylus 546 to appear similar to actual stylus 140, in some examples, virtual stylus 546 may be rendered to appear as the user-selected tool. Thus, a user who selects an airbrush will see virtual hand 124 holding an airbrush. In some examples, other aspects of the user-selected tool may be incorporated into virtual stylus 546. For example, a user may vary an amount of pressure applied to touch interaction surface 102 by stylus 140, and this may be represented visually by virtual stylus 546, e.g., with a color change, etc. or, in the case of a virtual paintbrush tool, by changing the shape of the brush tip.

In some examples, system 100 may detect the special case of a user using a computer mouse on touch interaction surface 102. The mouse's position and the location of the cursor on display 110 may not be directly related. Accordingly, in this special case system 100 may render the scaled representation of the mouse and the user's hand (scaled, for example, about the front edge of the mouse) at the cursor location, irrespective of the location of the physical mouse on touch interaction surface 102. Alternatively, the system may not render a representation of the mouse, or the hand holding it, at all.

Examples described herein are not limited to rendering a single virtual hand of a user. Techniques described herein may be employed to detect, scale, and render virtual representations of multiple hands of a single user, or even multiple hands of multiple users. Moreover, if any of the multiple detected hands is holding stylus 140, that may be detected and included in the virtual representation. In some examples in which multiple hands are detected, resulting in rendition of multiple virtual hands 124, the 3D representations of the multiple hands may be scaled together about a single scaling center. This may ensure that when fingers from different hands touch each other, which the user will feel, the fingers of the virtual hands will also appear to touch. Additionally or alternatively, in some examples, each virtual hand may be scaled separately about their own scaling center when the virtual hands are farther apart than some threshold, such as a fixed distance, a percentage of width of touch interaction surface, etc. When the user's hands are brought closer together, the multiple scaling centers may be transitioned to a single scaling center.

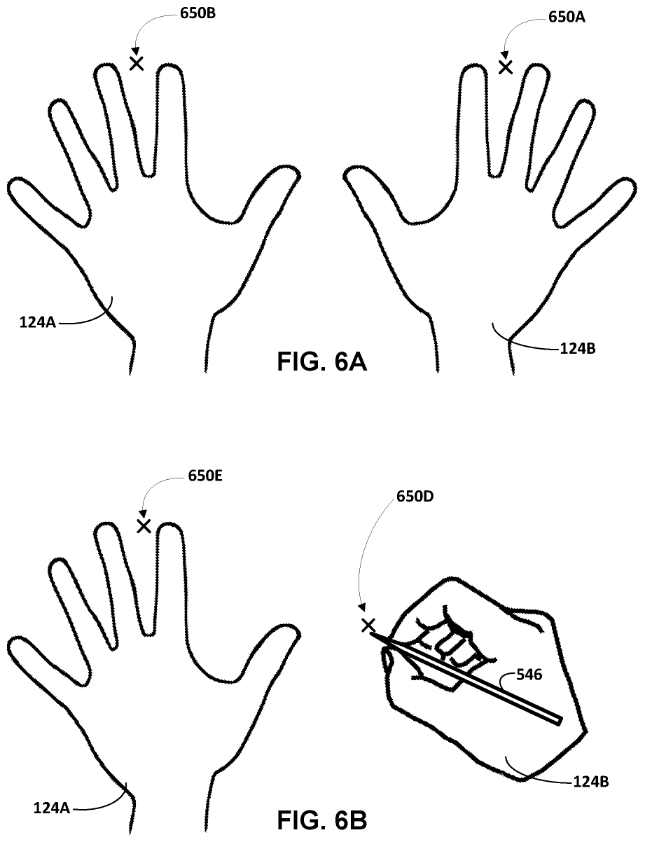

Referring now to FIG. 6A, a scenario is depicted in which multiple hands are detected, resulting in simultaneous rendition of multiple virtual hands 124A and 124B. For the sake of clarity, components such as touch interaction surface 102 and 3D vision sensor 106 are not depicted. In this example, neither hand grips a stylus. Various different scaling centers 650 may be identified depending on a number of factors, such as user preferences, learned user behavior, etc. For example, a dominant hand of the user may be identified, e.g., based on historical interaction with touch interaction surface 102. For example, the hand most often detected may be assumed to be dominant. Or, the relative positions of 3D vision sensor 106 and whichever display is being used (e.g., display 110) may indicate which hand is dominant. If touch interaction surface 102 is to the right of the display from the user's perspective, that may suggest the user's right hand is dominant. Likewise, if touch interaction surface 102 is to the left of the display from the user's perspective, that may suggest the user's left hand is dominant. And in some examples, the user may manually select which hand is dominant.

In FIG. 6A, if the user's right hand is identified as dominant, than the location 650A proximate right virtual hand 124B may be selected as the scaling center, e.g., for reasons similar as those described previously with relation to FIGS. 3A-B. Likewise, if the user's left hand is identified as dominant, than the location 650B proximate left virtual hand 124A may be identified as the scaling center.

FIG. 6B depicts a variation of the scenario of FIG. 6A. In FIG. 6B, a stylus 140 has detected in the user's right hand. Consequently, right virtual hand 124B is rendered holding virtual stylus 546. In this scenario, the location 650D of pen nib is always used as the scaling center for at least the hand holding the stylus (whether or not this hand is deemed by the system to be dominant). As above, the other hand may be rendered using its own scaling center 650E if it's sufficiently removed from the hand holding the stylus. The example scaling center locations of FIGS. 6A-B are not meant to be limiting. Other potential scaling center locations are possible.

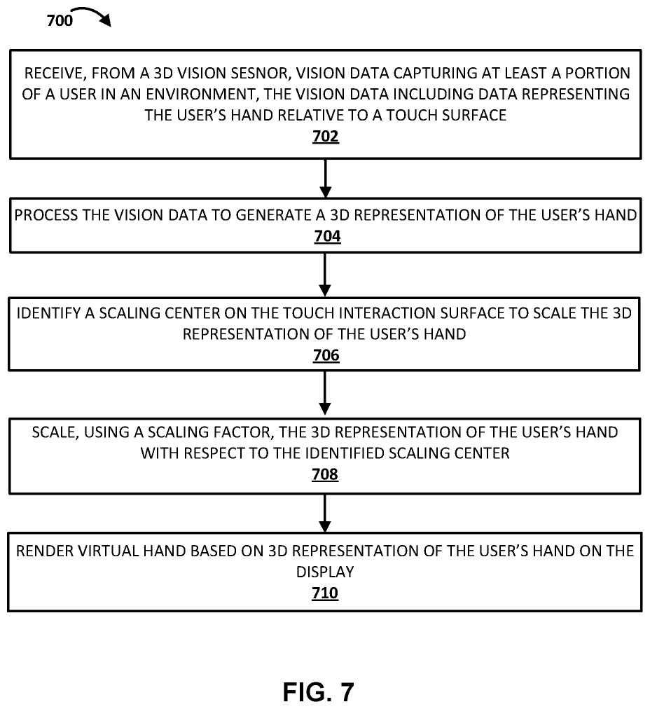

FIG. 7 illustrates a flowchart of an example method 700 for practicing selected aspects of the present disclosure. The operations of FIG. 7 can be performed by a processor, such as a processor of the various computing devices/systems described herein, including controller 112. For convenience, operations of method 700 will be described as being performed by a system configured with selected aspects of the present disclosure. Other examples s may include additional operations than those illustrated in FIG. 7, may perform operations (s) of FIG. 7 in a different order and/or in parallel, and/or may omit various operations of FIG. 7.

At block 702, the system may receive, from 3D vision sensor 106, vision data 116 capturing at least a portion of a user 122 in an environment. In various examples, the vision data may include data representing the user's hand 120 relative to touch interaction surface 102. At block 704, the system may process the vision data 116 to generate a 3D representation of the user's hand. This 3D representation may take the form of a 3D point cloud, a 3D skeletal model, etc.

At block 706, the system may identify a scaling center on touch interaction surface 102 to scale the 3D representation of the user's hand. Various examples of scaling centers are described herein, including those locations referenced by 350, 550, and 650. As noted herein, scaling centers may be identified based on fingertip locations, offset from a user's wrist, location of nib 142 of stylus 140, etc.

At block 708, the system may scale, using a scaling factor, the 3D representation of the user's hand with respect to (e.g., about) the scaling center identified at block 706. In various examples, the scaling factor may be based on various rendering constraints. Rendering constraints include but are not limited physical dimensions of a display, physical dimensions of touch interaction surface 102, distance of the user from display/touch interaction surface, orientation of virtual surfaces on which a virtual hand is to be rendered, an application window size, an orientation of the display, and so forth.

At block 710, the system may render a virtual hand. Rendering as used herein may refer to causing a virtual hand to be rendered on an electronic display, such as display 110, a display of an HMD, a projection screen, and so forth. However, rendering is not limited to causing output on a physical display. In some examples, rendering may include rendering data in a two-dimensional buffer and/or or in a two dimensional memory array, e.g., forming part of a graphical processing unit (“GPU”). In various examples, the virtual hand may be rendered based on the scaled 3D representation of the user's hand, and may be rendered realistically and/or abstractly, e.g., as a skeletal model, an outline/silhouette, cartoon, etc. The virtual hand may be rendered transparently to avoid occluding content already rendered on the display, e.g., by blending alpha channels.

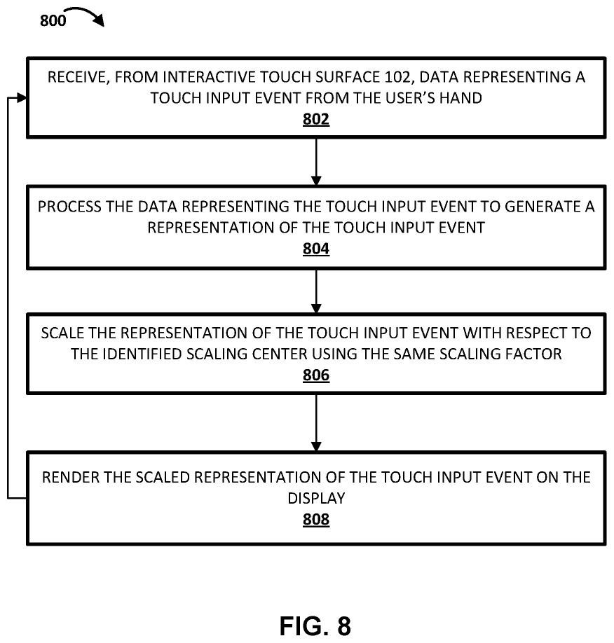

FIG. 8 illustrates a flowchart of an example method 800 for practicing selected aspects of the present disclosure related to rendering visual indications of touch input on the display along with the virtual hand. The operations of FIG. 8 can be performed by a processor, such as a processor of the various computing devices/systems described herein, including controller 112. For convenience, operations of method 800 will be described as being performed by a system configured with selected aspects of the present disclosure. One or more operations of FIG. 8 may be combined, omitted, and/or reordered. In some example, the operations of FIG. 8 may be interspersed with those operations depicted in FIG. 7.

At block 802, the system may receive, from touch interaction surface 102, data representing a touch input event from the user's hand, such as touch data 118. For example, the touch input event may include coordinates on touch interaction surface 102 at which physical contact is detected from user 122. Touch inputs may come in various forms, such as a tap or swipe, or multi-touch input events such as pinches, etc. Touch events may also be caused by various physical objects, such one or more fingers of the user, a stylus, or other implements such as brushes (which may not include paint but instead may be intended to mimic the act of painting), forks, rulers, projectors, compasses, or any other implement brought into physical contact with touch interaction surface 102.

At block 804, the system may process the data representing the touch input event to generate a representation of the touch input event. Non-limiting examples of representations of touch input events were indicated at 460 and 462 of FIG. 4. Representations of touch events may be generated in other forms as well, such as crosshairs, various shapes that emulate a brush stroke caused by whatever implement a user holds against touch interaction surface 102, gradients that have a density or thickness that is proportionate to a pressure applied by the user to touch interaction surface 102, and so forth.

At block 806, the system may scale the representation(s) of the touch input event(s) with respect to the identified scaling center using the same scaling factor as was used at block 708 of FIG. 7. As a consequence, the ultimate representation(s) of the touch events may be aligned spatially with the 3D representation of the user's hand, as is depicted in FIGS. 4A-B. At block 808, the system may render the scaled representation(s) of the touch input event(s), e.g., on a display, in conjunction with the virtual hand.

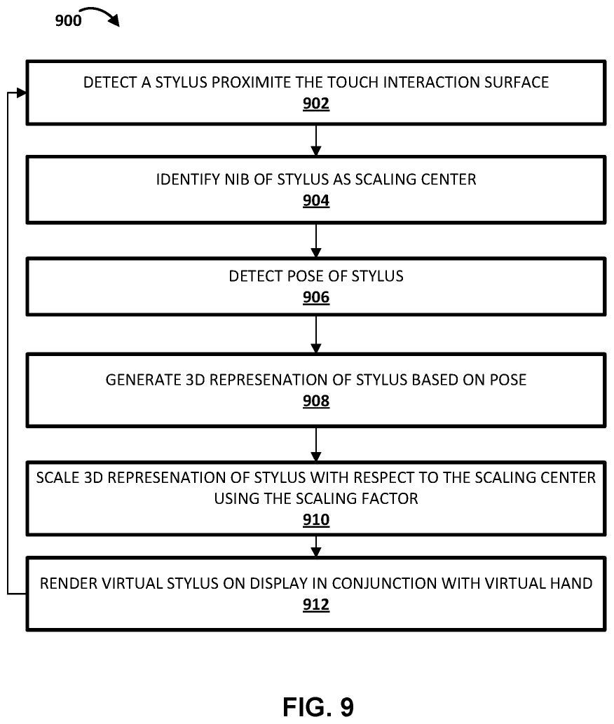

FIG. 9 illustrates a flowchart of an example method 900 for practicing selected aspects of the present disclosure related to rending a virtual stylus 546 along with the virtual hand 124. The operations of FIG. 9 can be performed by a processor, such as a processor of the various computing devices/systems described herein, including controller 112. For convenience, operations of method 900 will be described as being performed by a system configured with selected aspects of the present disclosure. One or more operations of FIG. 9 may be combined, omitted, and/or reordered. In some example, the operations of FIG. 9 may be interspersed with those operations depicted in FIGS. 7-8.

At block 902, the system may detect a stylus proximate touch interaction surface 102, e.g., based on wireless communication between the stylus and touch interaction surface 102, based on a detected position of the stylus relative to a known position of touch interaction surface 102, and/or based on the vision data 116 generated by 3D vision sensor 106. At block 904, which may occur alongside or in place of block 706 of FIG. 7, the system may identify the nib of the stylus as the scaling center.

At block 906, the system may detect a pose of the stylus, e.g., based on information provided by the stylus about its orientation, or based on an orientation of stylus detected in vision data 116. At block 908, the system may generate a 3D representation of the stylus based on the pose of the stylus detected at block 906. At block 910, the system may scale, e.g., using the same scaling factor as described previously, the 3D representations of the stylus with respect to the nib of the stylus.

At block 912, the system may render virtual stylus 546 on the display in conjunction with the virtual hand. In various examples, virtual stylus 546 may be based on the scaled 3D representation of actual stylus 140. In some examples, blending engine 236 may blend the 3D representation of the user's hand with the 3D representation of stylus 140 to generate a single 3D representation, which is then used to render a virtual hand holding a virtual stylus or other tool.

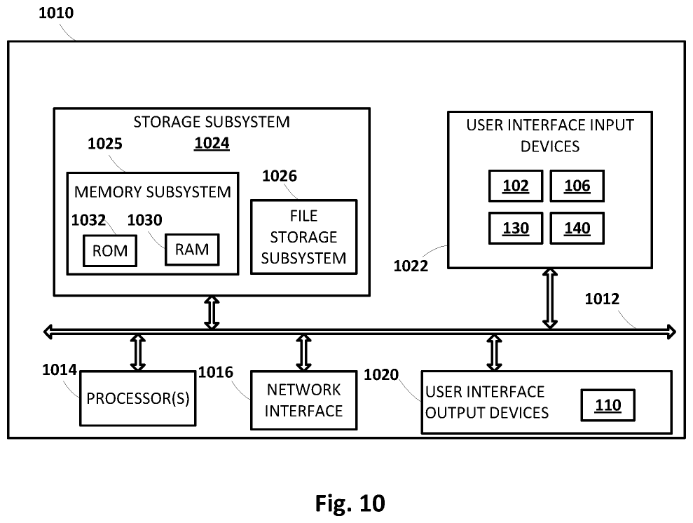

FIG. 10 is a block diagram of an example computer system 1010. Computer system 1010 typically includes at least one processor 1014 which communicates with a number of peripheral devices via bus subsystem 1012. These peripheral devices may include a storage subsystem 1026, including, for example, a memory subsystem 1025 and a file storage subsystem 1026, user interface output devices 1020, user interface input devices 1022, and a network interface subsystem 1016. The input and output devices allow user interaction with computer system 1010. Network interface subsystem 1016 provides an interface to outside networks and is coupled to corresponding interface devices in other computer systems.

User interface input devices 1022 may include input devices such as a keyboard, pointing devices such as a mouse, trackball, touch interaction surface 102 (which may take the form of a graphics tablet), a scanner, a touchscreen incorporated into the display, audio input devices such as voice recognition systems, microphones, 3D vision sensor 106, 2D camera 130, stylus 140, and/or other types of input devices. In general, use of the term “input device” is intended to include all possible types of devices and ways to input information into computer system 1010 or onto a communication network.

User interface output devices 1020 may include a display subsystem that includes display 110, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 1010 to the user or to another machine or computer system.

Storage subsystem 1026 stores programming and data constructs that provide the functionality of some or all of the modules described herein. For example, the storage subsystem 1026 may include the logic to perform selected aspects of methods 700-900.

These machine-readable instruction modules are generally executed by processor 1014 alone or in combination with other processors. Memory 1025 used in the storage subsystem 1026 can include a number of memories including a main random access memory (RAM) 1030 for storage of instructions and data during program execution and a read only memory (ROM) 1032 in which fixed instructions are stored. A file storage subsystem 1026 can provide persistent storage for program and data files, and may include a hard disk drive, a floppy disk drive along with associated removable media, a CD-ROM drive, an optical drive, or removable media cartridges. The modules implementing the functionality of certain examples may be stored by file storage subsystem 1026 in the storage subsystem 1026, or in other machines accessible by the processor(s) 1014.

Bus subsystem 1012 provides a mechanism for letting the various components and subsystems of computer system 1010 communicate with each other as intended. Although bus subsystem 1012 is shown schematically as a single bus, alternative examples of the bus subsystem may use multiple busses.

Computer system 1010 can be of varying types including a workstation, server, computing cluster, blade server, server farm, or any other data processing system or computing device. Due to the ever-changing nature of computers and networks, the description of computer system 1010 depicted in FIG. 10 is intended only as a specific example for purposes of illustrating some examples. Many other configurations of computer system 1010 are possible having more or fewer components than the computer system depicted in FIG. 10.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method implemented by a processor, the method comprising:
receiving, from a three-dimensional (“3D”) vision sensor, vision data capturing at least a portion of a user in an environment, the vision data including data representing the user's hand relative to a touch interaction surface;
processing the vision data to generate a 3D representation of the user's hand;
identifying a scaling center on the touch interaction surface to scale the 3D representation of the user's hand;
scaling, using a scaling factor, the 3D representation of the user's hand with respect to the identified scaling center, wherein the scaling factor is based on a rendering constraint; and
rendering a virtual hand, wherein the virtual hand is rendered based on the scaled 3D representation of the user's hand.

2. The method of claim 1, wherein the rendering constraint includes a dimension of a display to be used to render the 3D representation of the user's hand and a dimension of the touch interaction surface.

3. The method of claim 1, wherein identifying the scaling center on the touch interaction surface comprises identifying a location of a finger of the user.

4. The method of claim 1, wherein the 3D representation of the user's hand identifies a joint in the user's wrist, wherein identifying the scaling center on the touch interaction surface comprises identifying a location at a fixed offset from the joint in the user's wrist.

5. The method of claim 4, wherein the offset is learned based on previous interactions with the touch interaction surface.

6. The method of claim 1, wherein the rendering constraint further includes a distance of the user from a display.

7. The method of claim 1, wherein the touch interaction surface comprises an interactive touch surface, the method comprising:
receiving, from the interactive touch surface, data representing a touch input event from the user's hand;
processing the data representing the touch input event to generate a representation of the touch input event;
scaling, using the scaling factor, the representation of the touch input event with respect to the identified scaling center; and
rendering the scaled representation of the touch input event in conjunction with the virtual hand.

8. The method of claim 1, comprising:
detecting a stylus proximate the touch interaction surface; and
identifying a nib of the stylus as the scaling center.

9. The method of claim 8, comprising:
detecting a pose of the stylus;
generating a 3D representation of the stylus based on the pose of the stylus;
scaling, using the scaling factor, the 3D representations of the stylus with respect to the nib of the stylus; and
rendering a virtual stylus in conjunction with the scaled 3D representation of the user's hand, wherein the virtual stylus is based on the scaled 3D representation of the stylus.

10. The method of claim 9, wherein the scaled virtual stylus is rendered disguised as a user-selected tool.

11. The method of claim 1, wherein the hand is a first hand of the user, the vision data further includes data representing a second hand of the user relative to the touch interaction surface, and wherein the scaling center is identified based on:
one of the first and second hands identified as dominant; or
one of the first and second hands determined to be grasping a stylus.

12. A system comprising:
a three-dimensional (“3D”) vision sensor;
a processor operably coupled with the vision sensor and memory storing instructions that, when executed, cause the processor to:
receive, from the 3D vision sensor, vision data capturing at least a portion of a user in an environment, including the user's hand relative to a touch interaction surface;
process the vision data to generate a 3D representation of the user's hand;
identify, as a scaling center, a primary point of physical interaction between the user and the touch interaction surface;
scale, using a scaling factor, the 3D representation of user's hand with respect to the identified scaling center, wherein the scaling factor is based on a distance between an eye of the user and the touch interaction surface; and
render a virtual hand, wherein the virtual hand is rendered based on the 3D representation of the user's hand.

13. The system of claim 12, wherein the scaling center is identified on the touch interaction surface based on:
a location of a finger of the user;
a location of a nib of a stylus; or
a location on the touch interaction surface that is learned based on previous interactions with the touch interaction surface.

14. The system of claim 12, wherein the 3D representation of the user's hand identifies a joint in the user's wrist, wherein identifying the scaling center on the touch interaction surface comprises identifying a location at a fixed offset from the joint in the user's wrist, wherein the offset is learned based on previous interactions with the touch interaction surface.

15. A non-transitory computer-readable medium comprising instructions that, in response to execution of the instructions by a processor, cause the processor to:
process vision data capturing a user's hand relative to a touch interaction surface to generate a three-dimensional (“3D”) representation of the user's hand;
scale, using a scaling factor, the 3D representation of the user's hand with respect to a point relative to the user's hand, wherein the scaling factor is based on:
a dimension of a display to be used to render the scaled 3D representation of the user's hand and a dimension of the touch interaction surface, or
a distance of the user from the display; and
render a virtual hand, wherein the virtual hand is rendered based on the scaled 3D representation of the user's hand on the display.
